(19) United States
(12) Patent Application Publication
(10) Pub. No.: US 2019/0350350 A1
(43) Pub. Date: Nov. 21, 2019

(54) WEARABLE ACCESSORY ATTACHMENT DEVICE

(71) Applicant: Red Armfield, West Point, UT (US)

(72) Inventor: Red Armfield, West Point, UT (US)

(21) Appl. No.: 15/981,343

(22) Filed: May 16, 2018

(51) Int. Cl. A45F 5/00; B26B 29/02

(52) U.S. Cl. CPC A45F 5/00; A45F 2200/0575; B26B 29/025

(57) ABSTRACT

A wearable accessory attachment device, including a main body having a portion thereof capable of bring threaded through a belt loop of a knife case, a first strap connected to a first end of the main body, the first strap comprising first connectable end portions, and a second strap connected to a second end of the main body, the second strap second comprising connectable end portions.

### BACKGROUND

### 1. Field

The present general inventive concept relates generally to a wearable accessory attachment device.

### 2. Description of the Related Art

Those in the military or police force, or hunters, may encounter problems with keeping their small accessories on hand when gearing up. At present, certain items used by these persons are not able to be transported as easily with other wearable gear unless they travel with the person via belt, which is not always immediately possible to ensure, especially in extreme cases of emergency where speed is key to diffusing an intense situation.

Therefore, there is a need for a way to allow users to easily wear and access their small accessories.

### SUMMARY

The present general inventive concept provides a wearable accessory attachment device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a wearable accessory attachment device, including a main body having a portion thereof capable of bring threaded through a belt loop of a knife case, a first strap connected to a first end of the main body, the first strap comprising first connectable end portions, and a second strap connected to a second end of the main body, the second strap second comprising connectable end portions.

The main body may have a rectangular shape.

The main body may include a first canal disposed at the first end of the main body across an entire width of the main body to receive at least a portion of the first strap therein, and a second canal disposed at the second end of the main body across the entire width of the main body to receive at least a portion of the second strap therein.

The first and second connectable end portions may each include a female snap, and a male snap to enter and attach to the female snap.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a wearable accessory attachment device, according to an exemplary embodiment of the present general inventive concept; and

FIG. 2 illustrates the wearable accessory attachment device attached to a knife case, according to another exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

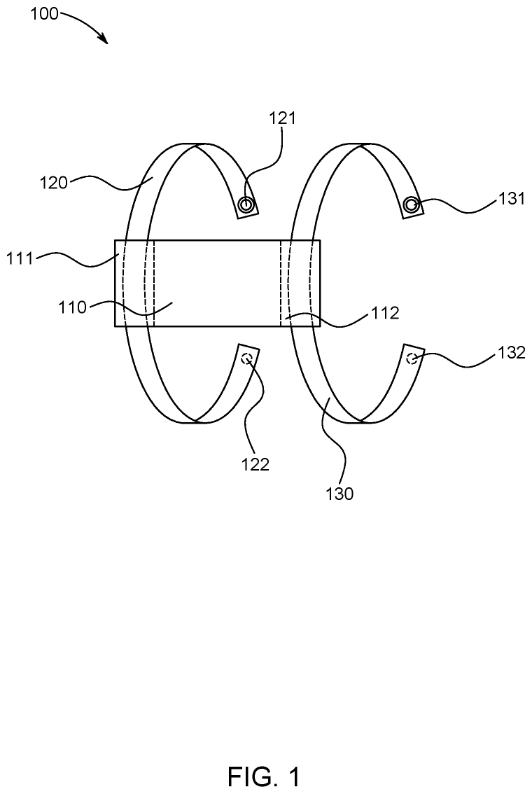

FIG. 1 illustrates a wearable accessory attachment device 100, according to an exemplary embodiment of the present general inventive concept.

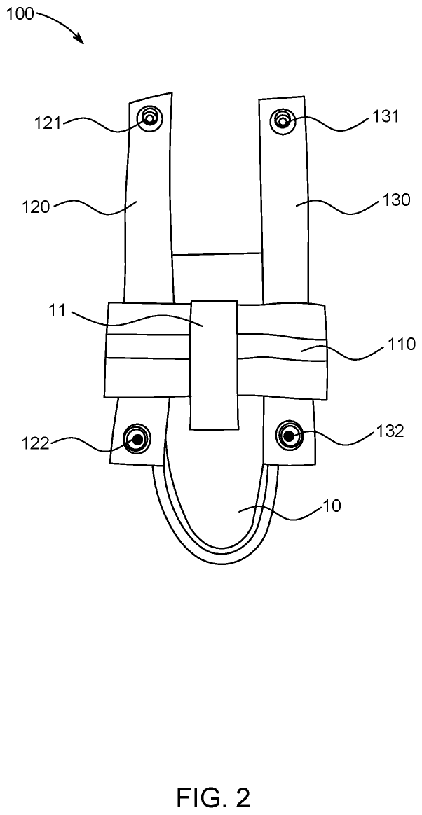

FIG. 2 illustrates the wearable accessory attachment device 100 attached to a knife case 10, according to another exemplary embodiment of the present general inventive concept.

The wearable accessory attachment device 100, and components thereof, may be constructed from cloth, cotton, polyester, threads, metal, plastic, rubber, wood, or any other material known to one of ordinary skill in the art.

The wearable accessory attachment device 100 may be designed to have attached thereto anything that could be carried on a belt, including phones, knives, GPS devices, range finders, gun holsters, wallet chains, etc., but is not limited thereto.

The wearable accessory attachment device 100 may include a main body 110, a first strap 120, and a second strap 130, but is not limited thereto.

The body main 110 may have various shapes and sizes, and may have a substantially rectangular shape, but is not limited thereto.

The main body 110 may include a first canal 111 disposed at a first end of the main body 110, such that the first canal 111 is an empty space through an entire width of the main body 110. The first canal 111 may have a predetermined size, such that the first strap 120 may be threaded therethrough.

The main body 110 may also include a second canal 112 disposed at a second end of the main body 110, such that the second canal 112 is an empty space through an entire width of the main body 110. The second canal 112 may have a predetermined size, such that the second strap 130 may be threaded therethrough.

In other words, the first canal 111 may be disposed at the first end of the main body 110 across an entire width of the main body 110 to receive at least a portion of the first strap 111 therein, the second canal 112 may be disposed at the second end of the main body 110 across the entire width of the main body 110 to receive at least a portion of the second strap 112 therein.

As such, the first strap 120 may be connected to the first end of the main body 110, and the second strap 130 may be connected to the second end of the main body 110. In other words, the first strap 120 may include first connectable end portions, and the second strap 130 may include second connectable end portions.

The main body 110 may be threaded through a belt loop 11 of the knife case 10, in order to allow a user to wear the knife case 10 on an area of his/her body besides a belt, as depicted in FIG. 2.

The first strap 120 may include a male snap 121 disposed at a first end of the first strap 120, and a female snap 122 disposed at a second end of the first snap 120. The male snap 121 may snap into the female snap 122 in order to cause the first strap 120 to form a loop.

The second strap 130 may include a male snap 131 disposed at a first end of the second strap 130, and a female snap 132 disposed at a second end of the second snap 130. The male snap 131 may snap into the female snap 132 in order to cause the second strap 130 to form a loop.

Alternatively, the male snap 121, the female strap 122, the male snap 131, and the female snap 132 may be replaced with hooks, loops, buttons, VELCRO, or any other type of connecting member known to one of ordinary skill in the art.

The first strap 120 and the second strap 130 may be used to loop around a user's arm or MOLLE gear, so that the user may wear the knife case 10.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A wearable accessory attachment device, comprising:
a main body having a portion thereof capable of being threaded through a belt loop of a knife case, the main body being constructed from at least one of cloth, cotton, polyester, threads, and rubber, such that the main body is deformable to allow the main body to enter into the belt loop in response to the belt loop having a thickness that is smaller than another thickness of the main body, the main body comprising:
a first canal disposed at the first end of the main body across an entire width of the main body to receive at least a portion of the first strap therein, and;
a second canal disposed at the second end of the main body across the entire width of the main body to receive at least a portion of the second strap therein;
a first strap connected to a first end of the main body, the first strap comprising first connectable end portions, such that a width of the first strap is substantially less than a width of the first canal, such that the first strap moves at least partially in a first lateral direction or a second lateral direction within the first canal; and
a second strap connected to a second end of the main body, the second strap comprising second connectable end portions, such that a width of the second strap is substantially less than a width of the second canal, such that the second strap moves at least partially in the first lateral direction or the second lateral direction within the second canal.

2. The wearable accessory attachment device of claim 1, wherein the main body has a rectangular shape.

3. (canceled)

4. The wearable accessory attachment device of claim 1, wherein the first and second connectable end portions each comprise:
a female snap; and
a male snap to enter and attach to the female snap.

5. A wearable accessory attachment device, comprising:
at least one strap having a predetermined size, comprising:
a female snap disposed at a first end, and
a male snap disposed at a second end to enter and attach to the female snap; and
a main body having a portion thereof capable of being threaded through a belt loop of a knife case, the main body comprising:
at least one canal disposed within an interior portion of the main body to receive at least a portion of the at least one strap, such that the main body deforms in response to pulling both ends of the at least one strap, such that a width of the at least one strap is substantially less than a width of the at least one canal, such that the at least one strap moves at least partially in a first lateral direction or a second lateral direction within the at least one canal.
